(19) United States
(12) Patent Application Publication
(10) Pub. No.: US 2017/0048001 A1
(43) Pub. Date: Feb. 16, 2017

(54) Apparatus and Method for Isolating an Optical Signal by Subtracting the Atmospheric Background in Real Time

(71) Applicant: SPAWAR Systems Center Pacific, San Diego, CA (US)

(72) Inventors: David T. Wayne, San Diego, CA (US); James Richard Adleman, San Diego, CA (US); Galen David Cauble, San Diego, CA (US); Michael Garrett Lovern, Chula Vista, CA (US)

(21) Appl. No.: 15/234,894

(22) Filed: Aug. 11, 2016

Related U.S. Application Data
(60) Provisional application No. 62/203,807, filed on Aug. 11, 2015.

(51) Int. Cl. H04B 10/61; H04B 10/11

(52) U.S. Cl. CPC H04B 10/616; H04B 10/11

(57) ABSTRACT

A method for isolating an optical signal comprising the following steps: receiving the optical signal from a transmitter with a receiver after the optical signal has propagated through a turbulent medium separating the transmitter from the receiver; splitting the received signal into first and second signals; filtering the first signal with an in-band spectral filter to create an in-band signal centered at an operating wavelength of the transmitter; filtering the second signal with an out-of-band spectral filter to create an out-of-band signal slightly out-of-band with respect to the operating wavelength of the transmitter; and subtracting the out-of-band signal from the in-band signal with a balanced detector in order to generate an output signal, whereby the output signal is a real-time representation of the intensity of the optical signal without background intensity.

### CROSS-REFERENCE TO RELATED APPLICATION

This application claims the benefit of prior U.S. Provisional Application No. 62/203,807, filed 11 Aug. 2015, titled “Implementation of a balanced detector receiver to automatically subtract background of an optical signal to measure scintillation over a turbulent atmospheric propagation channel” (Navy Case #103073).

### FEDERALLY-SPONSORED RESEARCH AND DEVELOPMENT

The United States Government has ownership rights in this invention. Licensing and technical inquiries may be directed to the Office of Research and Technical Applications, Space and Naval Warfare Systems Center, Pacific, Code 72120, San Diego, Calif., 92152; voice (619) 553-5118; ssc_pac_t2@navy.mil. Reference Navy Case Number 103073.

### BACKGROUND OF THE INVENTION

When a laser beam propagates through the atmosphere, the turbulence induces intensity fluctuations on the beam yielding a statistically random spatial intensity at the receiver. The scintillation index is a parameter often used to describe the magnitude of the turbulence-induced fluctuations and overall characterize the strength of turbulence. Because the laser power at the receiver may be low due to the fluctuations, atmospheric background (i.e. incoherent scattered light from the sun or other sources) contributes significantly to the output power of the receiver and cannot be neglected. However, since the incoherent background does not fluctuate strongly with atmospheric turbulence, it is usually assumed to be a DC value across the timescale of the laser intensity fluctuations.

Traditionally, when measuring the scintillation index, the optical signal (including background) is captured with a detector, amplified, and then digitized into software. In order to calculate the scintillation index, the DC background must be subtracted from the optical signal. Background subtraction is commonly done by taking a time-averaged signal measurement with the laser off before and after the measurement of interest is conducted. The background measurements before and after the laser measurement are averaged together to produce the representative background. It is assumed the background does not change over the measurement period. There is a need for an improved method and apparatus for isolating an optical signal of interest.

### SUMMARY

Disclosed herein is a method and apparatus for isolating an optical signal. The optical signal isolation method comprises the following steps. The first step provides for receiving the optical signal from a transmitter with a receiver after the optical signal has propagated through a turbulent medium separating the transmitter from the receiver. The next step provides for splitting the received signal into first and second signals. The next step provides for filtering the first signal with an in-band spectral filter to create an in-band signal centered at an operating wavelength of the transmitter. The next step provides for filtering the second signal with an out-of-band spectral filter to create an out-of-band signal slightly out-of-band with respect to the operating wavelength of the transmitter. The next step provides for subtracting the out-of-band signal from the in-band signal with a balanced detector in order to generate an output signal, whereby the output signal is a real-time representation of the intensity of the optical signal without background intensity.

The optical signal isolation apparatus comprises a receiver, an optical device, an in-band spectral filter, and out-of-band spectral filter and a balanced detector. The receiver is configured to receive an optical signal from a transmitter after the optical signal has propagated through a turbulent medium. The optical device is optically coupled to the receiver and configured to split the optical signal into first and second signals. The in-band spectral filter is configured to filter the first signal to create an in-band signal centered at an operating wavelength of the optical signal. The out-of-band spectral filter is configured filter the second signal to create an out-of-band signal that is slightly out-of-band with respect to the operating wavelength of the transmitter. The balanced detector is configured to subtract the out-of-band signal from the in-band signal in order to generate an output signal. The output signal is a real-time representation of the intensity of the optical signal without background intensity.

### BRIEF DESCRIPTION OF THE DRAWINGS

Throughout the several views, like elements are referenced using like references. The elements in the figures are not drawn to scale and some dimensions are exaggerated for clarity.

FIG. 1 is a block diagram of an optical signal isolation apparatus.

FIG. 2 is a flowchart.

FIG. 3 is an illustration of an embodiment of an optical signal isolation apparatus.

FIG. 4 is an electrical schematic of a balanced detector.

FIG. 5 is an illustration of an embodiment of an optical signal isolation apparatus.

FIG. 6 is a graph showing sample data collected during an experiment.

FIGS. 7A-7D are graphs of experimental result data.

### DETAILED DESCRIPTION OF EMBODIMENTS

The disclosed methods and systems below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other methods and systems described herein as will be understood by one of ordinary skill in the art unless otherwise stated specifically.

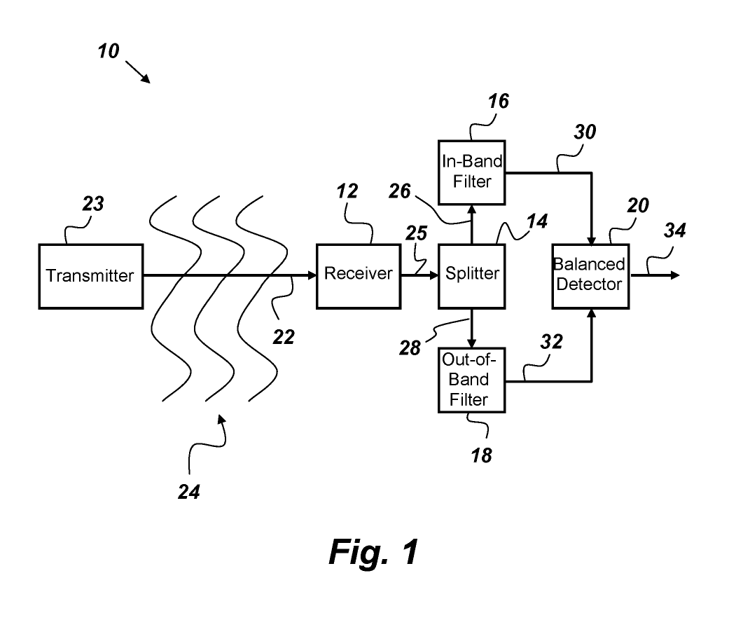

FIG. 1 is a block diagram illustrating an optical signal isolation apparatus 10 that comprises, consists of, or consists essentially of a receiver 12, an optical device 14, an in-band spectral filter 16, and out-of-band spectral filter 18, and a balanced detector 20. The receiver 12 is configured to receive an optical signal 22 from a transmitter 23 after the optical signal 22 has propagated through a turbulent medium 24. The optical device 14 is optically coupled to the receiver 12 and configured to split the optical signal 22 into first and second signals 26 and 28 respectively. The in-band spectral filter 16 is configured to filter the first signal 26 to create an in-band signal 30 that is centered at an operating wavelength of the transmitter 23. The out-of-band spectral filter 18 is configured filter the second signal 28 to create an out-of-band signal 32 that is slightly out-of-band with respect to the operating wavelength of the transmitter 23. As used herein, the term “slightly out-of-band” means close to, but outside of, the transmitter's wavelength (e.g., several nanometers away from the operating wavelength of the transmitter 23) such that the transmitter 23 has no effect on the out-of-band signal 32. The balanced detector 20 is configured to subtract the out-of-band signal 32 from the in-band signal 30 in order to generate an output signal 34. The output signal 34 is a real-time representation of the intensity of the optical signal 22 without background intensity from the turbulent medium 24.

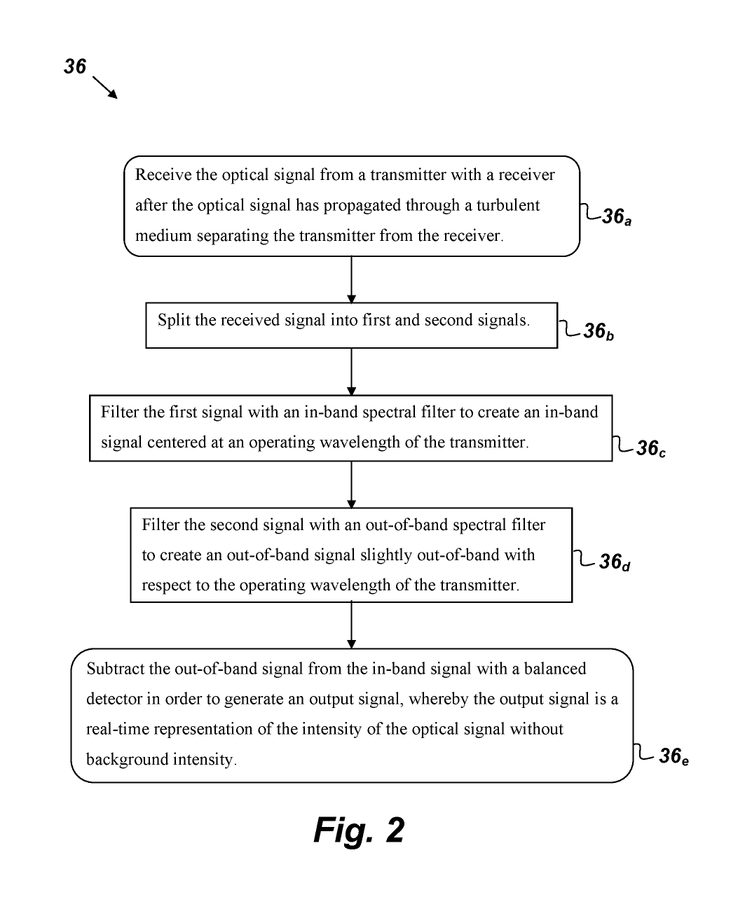

FIG. 2 is a flowchart of a method 36 for using the optical signal isolation apparatus 10 shown in FIG. 1 to isolate an optical signal of interest (i.e., optical signal 22) by subtracting the atmospheric background in real time. The first step 36ₐ provides for receiving the optical signal 22 from the transmitter 23 with the receiver 12 after the optical signal 22 has propagated through the turbulent medium 24 that separates the transmitter 23 from the receiver 12. The next step 36_{b} provides for splitting the received signal 25 into the first and second signals 26 and 28. The next step 36_{c} provides for filtering the first signal 26 with an in-band spectral filter 16 to create an in-band signal 30 centered at an operating wavelength of the transmitter 23. The next step 36_{d} provides for filtering the second signal 28 with an out-of-band spectral filter 18 to create an out-of-band signal 32 that is slightly out-of-band with respect to the operating wavelength of the transmitter 23. The next step 36ₑ provides for subtracting the out-of-band signal 32 from the in-band signal 30 with the balanced detector 20 in order to generate the output signal 34. Additionally, subtracting the background as done by method 36 prior to amplification of the optical signal 22 reduces the noise at the input of the amplifier and also increases the dynamic range by removing the often large DC bias of the received signal 25.

Atmospheric events can cause fluctuations in background signal during data collection. If background is recorded asynchronously to data collection these changes will be unaccounted for. In order to completely account for these changes background signal and data must be recorded simultaneously. The optical signal isolation apparatus 10 allows for synchronous background and data measurement for use in a more accurate calculation of the scintillation index. The scintillation index is a statistical parameter characterizing the turbulence-induced fluctuations in received optical signal intensity. The scintillation index (referenced herein as SI or σ_{I}²) is the variance of the received intensity normalized by the square of the signal mean σ, thus yielding a parameter independent of initial transmitted optical power.

$$SI = {σ}_{I}^{2} = \frac{〈 {I}^{2} 〉 - {〈 I 〉}^{2}}{{〈 I 〉}^{2}} = \frac{〈 {I}^{2} 〉}{{〈 I 〉}^{2}} - 1 \qquad ( 1 )$$

Where σ_{I}² is the scintillation index and I is the received intensity of the optical signal 22. The scintillation index is proportional to the refractive index structure parameter under weak fluctuations, as shown in the classic equation for Rytov variance of a plane wave.

σ_{I}²=1.23Cₙ²k^{7/6}L^{11/6} (2)

Where Cₙ² is the refractive index structure parameter, k is the wave number, and L is the path length. It is implied that the background (any additive signal not due to the transmitter) is subtracted from the recorded intensity,

$${σ}_{I}^{2} = \frac{〈 {I}^{2} 〉}{{〈 I 〉}^{2}} - 1 = \frac{〈 {( I - BG )}^{2} 〉}{{〈 I - BG 〉}^{2}} - 1 \qquad ( 3 )$$

where BG is a constant measured background signal. Note the non-linear dependence on an additive offset to the intensity signal, therefore it is paramount to accurately subtract the background before calculating the scintillation index as otherwise error will be introduced. In order to account for a fluctuating background the constant BG is replaced with the variable bg, this becomes clearer when the scintillation index is re-written in summation notation as follows:

$${σ}_{I}^{2} = \frac{〈 {( I - bg )}^{2} 〉}{{〈 I - bg 〉}^{2}} - 1 = \frac{[ {( \sum {I}_{n} - {bg}_{n} )}^{2} ] * n}{{( \sum {I}_{n} - {bg}_{n} )}^{2}} - 1 \qquad ( 4 )$$

where bg is the simultaneously measured background intensity during sample collection, Iₙ represents a single intensity measurement from the array of intensity I values, and bgₙ represents a single background measurement from the array of simultaneously-measured background intensity bg values. Note that each intensity measurement now has a corresponding unique background measurement. This ensures a correct subtraction of background regardless of any events which may change the intensity of the background scene and removes the need to measure background separately from (before and/or after) sample collection. The optical signal isolation apparatus 10 allows for scintillation index SI measurements from a continuous wave source, which need not be cooperative, while allowing uninterrupted data collection at the receiver end.

The optical signal 22 may be a laser or other optical signal that is transmitted from a known/defined optical system and propagated through the turbulent medium 24, such as the atmosphere. The atmosphere will impart intensity fluctuations on the propagating optical signal 22 due to atmospheric turbulence. The received signal 25 will be split from a single beam into two beams and then passed through the spectral filters 16 and 18: one in-band and one slightly out of band (i.e. signal+background, and background only). The two beams will then be filtered and go into the balanced detector 20 to convert the first and second signals 26 and 28 to an electrical current (photocurrent).

The receiver 12 may be any optical system capable of collecting and concentrating the optical signal 22. The optical device 14 may be any splitter capable of splitting the received signal 25 into the first and second signals 26 and 28. A suitable example of the optical device 14 is a beam splitter prism. In an embodiment of the optical signal isolation apparatus 10, the optical device 14 and the in-band and out-of-band filters are embodied by an appropriately-chosen dichroic mirror/filter, which both splits and filters the received signal 25.

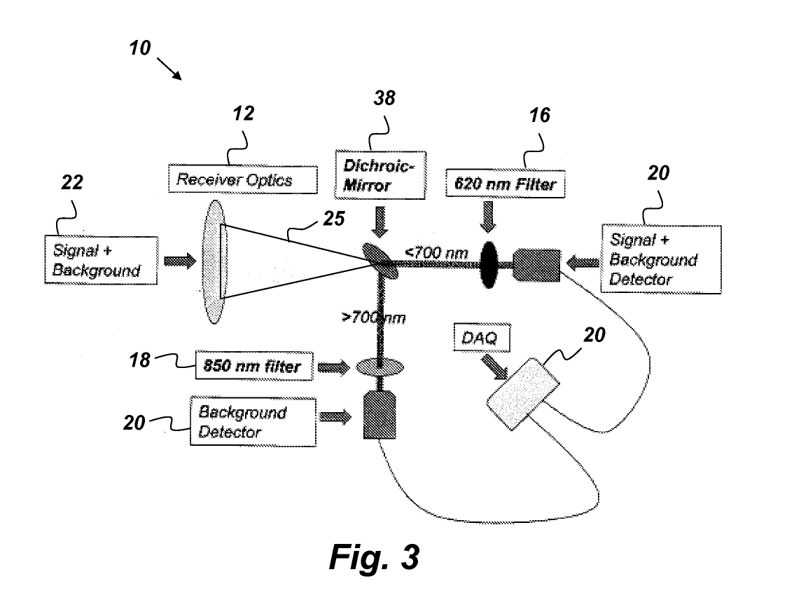

FIG. 3 is an illustration of an example embodiment of the optical signal isolation apparatus 10 where the optical device 14 and the in-band and out-of-band filters are embodied by a dichroic mirror 38. This embodiment of the optical signal isolation apparatus 10 allows an increased signal on the in-band leg (i.e., the in-band signal 30) and more accurate filtering on both legs. Each signal would go to a leg of the balanced detector 20 and the slow changing of the background would be subtracted in real time during the measurement, before any amplification or digitization of the signal. This is useful in the case of scintillation measurements, where DC background is always subtracted from the signal before the scintillation index is calculated. When properly oriented a dichroic mirror will split light at an engineered wavelength, reflecting one band and transmitting the other. A dichroic mirror may be selected such that its transmitted light contains the in-band filter's wavelength and reflected light contains at the out-of-band filter's wavelength. The use of the dichroic mirror also increases signal by 3 dB on the in-band leg as no signal is reflected to the out-of-band leg as with a prism. To calibrate the device the in-band signal and out-of-band signal must be equal when the source (i.e., the transmitter 23) is off. Due to the non-uniformity of solar background intensity, optical loses, and detector responsivity, the in-band and out-of-band signals will differ in intensity. Balancing both signals (either by electrical attenuation or optomechanical filtering) will cause the output of the balanced detector 20 to measure zero.

When the balanced detector 20 is calibrated, the out-of-band signal 32 becomes a direct representation of the background from the in-band signal 30. With the transmitter 23 switched on, the output 34 of the balanced detector 20 is now a direct measurement of the intensity of the optical signal 22 with any background already subtracted. Additionally, changes in background intensity will similarly affect both signals and cause no change in output. This setup achieves real-time hardware background subtraction. While a balanced detector 20 allows real-time subtraction of background, is it not necessary for simultaneous background measurements. In its place two detectors can be used and the signal may be subtracted in post-detection. Additionally, if hardware calibration is not used both signals can be calibrated post-detection.

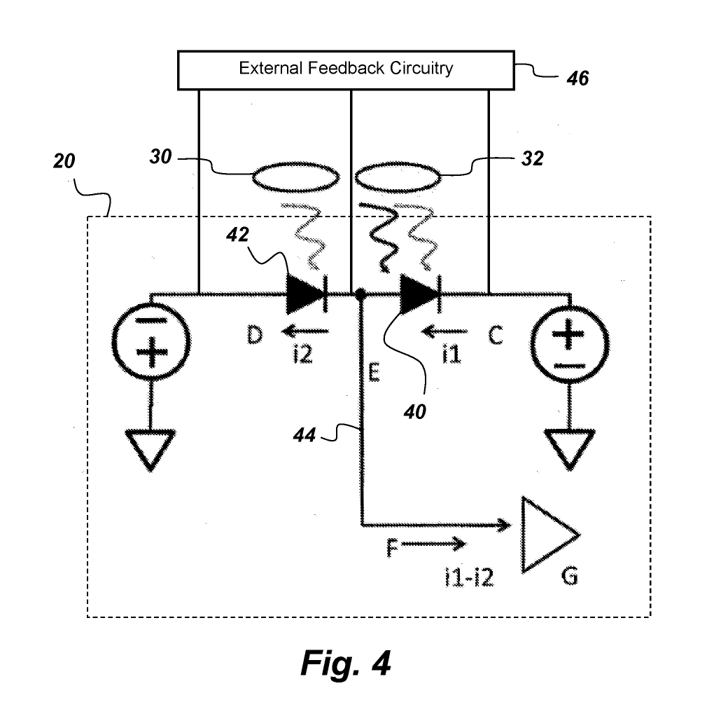

FIG. 4 is a schematic of an example embodiment of the balanced detector 20. In FIG. 4, the reference character C represents photocurrent (signal) generated from the out-of-band optical signal 32; the reference character D represents photocurrent (signal) generated from the in-band optical signal 30; the reference character E represents a node in the electrical circuit where the two photocurrents are summed; and the reference character F represents the differential (balanced) signal input into an amplifier. In this embodiment, the balanced detector comprises a first photodiode 40 and a second photodiode 42. Both the first and second photodiodes 40 and 42 have approximately identical responsivity and are connected in series. The photocurrent induced in one diode is subtracted from the other by providing an output path 44 (shunt) at the connection between the diodes. Any fluctuation common to both diodes (e.g. common mode noise) is effectively rejected from the output. External feedback circuitry 46 can optionally be used to adjust diode bias points to compensate for slight differences in photodiode responsivity due to practical fabrication issues. The electrical schematic shown in FIG. 4 labels the noise currents for balanced detection. Note that the background signal is removed for balanced detection, even in the case of a fluctuating background. This allows for increased sensitivity of detection of optical signal fluctuations since it removes the ambiguity between optical signal fluctuations and atmospheric background fluctuation. Additionally removing the dc bias due to both atmospheric background and photodetector dark current allows a greater dynamic range for both photodetection and digitization.

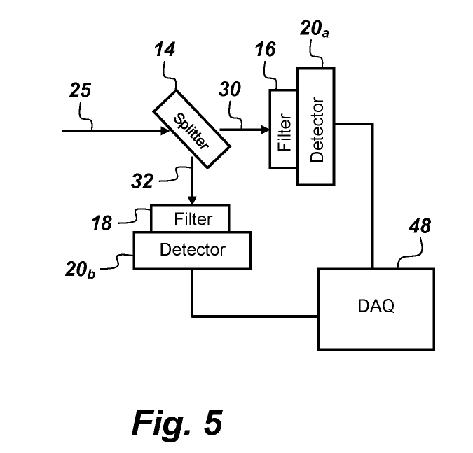

FIG. 5 is an illustration of an embodiment of the optical signal isolation apparatus 10 that utilizes dual detectors 20ₐ and 20_{b}. In this embodiment, the dual detectors 20ₐ and 20_{b} are 3.6 mm square PDA36A switchable gain detectors. Optionally, one may collimate the optical signal 22 at the receiver 12 using a negative lens to create a pseudo-beam expander. In this embodiment, the dual detectors 20ₐ and 20_{b} were positioned entirely inside of the focal plane of the receiver 12 which allows the intensity of the source and background to be measurable by the dual detectors 20ₐ and 20_{b}. In this embodiment, the rest of the receiver optics (not shown in FIG. 5) consisted of a 120 mm diameter, 450 mm focal length lens as our collecting optics, Thorlabs M254H45 hot mirror, Thorlabs FB620-10 620 nm 10 FWHM filter for the in-band signal 30, and an FB850-10 850 nm 10 FWHM filter for the out-of-band signal 32. The dual detectors 20ₐ and 20_{b} were connected to a data acquisition (DAQ) module 48, which in this embodiment was a National Instruments USB-4431 24-Bit DAQ. The optical signal 22 in this embodiment was a 620 nm partially coherent LED source operated in continuous wave mode with a peak intensity at 620 nm. The output intensity could be adjusted by changing the current supplied to the LED.

An experiment was conducted with the embodiment of the optical signal isolation apparatus 10 depicted in FIG. 5. In the experiment a separate LED peaking at 850 nm and was used to align the out-of-band optical leg to ensure both detectors had identical fields of view. The source and receiver optics were separated by a 383 m path. Each source was turned on and adjusted to their respective optical leg (620 nm transmitter on in-band leg, 850 nm transmitter on out-of-band leg). This ensured that each detector's field of view was centered on the transmitter and viewing the same background scene. Note that in this experiment, the 850 nm LED was only used during alignment and remained off for the duration of sample collection.

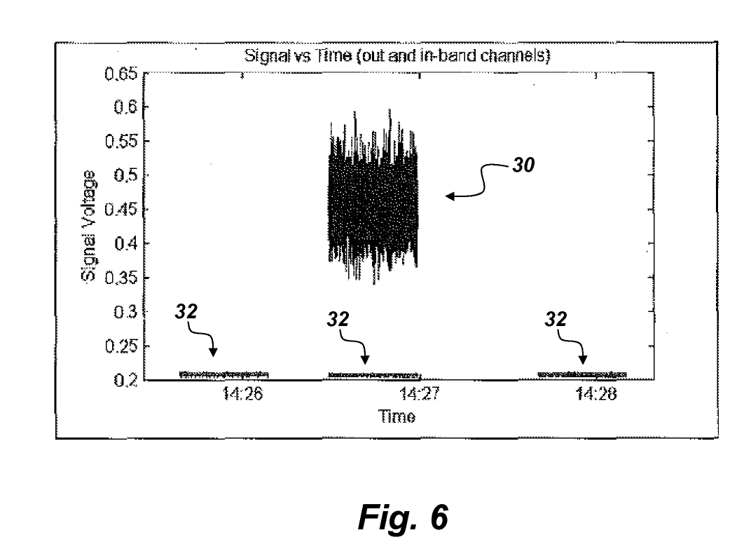

FIG. 6 is a graph showing sample data collected during the experiment mentioned above. The in-band signal is shown by the traces in the center of the graph. The out-of-band signal is shown by the traces on the bottom of the graph. Data were collected four times during the day to span a range of atmospheric effects. Collections took place at 0900, 1200, 1500, and 2200. The data were recorded at 50 kHz to ensure that turbulence was oversampled. Collection consisted of a 30 second background measurement, followed by 30 seconds of source, and another 30 seconds of background as shown in FIG. 6. This testing plan was chosen to allow a precise estimation of background and a long enough signal collection to allow atmospheric fluctuations. Each collection was repeated for a variety of optical powers. Both detectors were set at 60 dB gain. FIG. 6 shows that even without hardware calibration both legs appear to be similar in intensity during background collection. Even so, calibration was done post-detection by finding a relationship between the in-band and out-of-band background signals. If the signals are similar in wavelength their background intensities are assumed to be directly proportional. That is, the in-band and out-of-band signal are related by a constant calibration factor, R.

$$R = \frac{〈 {in\_band}_{BG} 〉}{{〈 out\_of \_band 〉}^{′}} \qquad ( 5 )$$

where (in_band_{BG}) and (out_of_band)′ are the average values of the in-band signal and out-of-band signal during a background measurement (as discussed above). This calibration constant scales any out-of-band measurement to the background of the in-band signal

in_band=out_of_band*R. (5)

Once R was calculated the out-of-band signal was scaled to and subtracted from the in-band signal after sample collection. Due to the fact that the filters in this experiment were separated by around 230 nm the ratio between the legs was not constant throughout the day. This means that for each data collection a unique proportionality constant, R, was calculated.

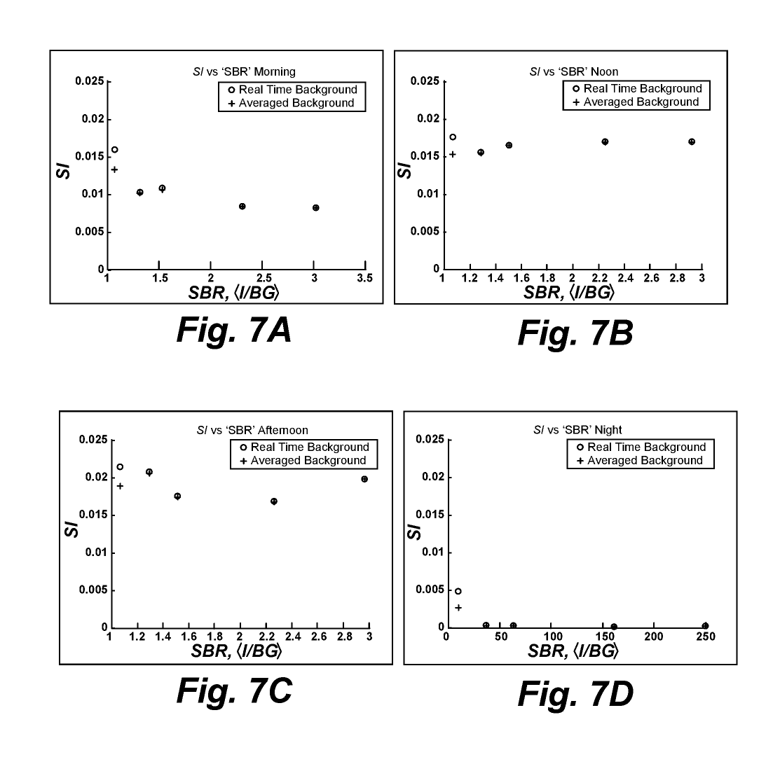

FIGS. 7A-7D are graphs showing calculated scintillation index as a function of the average signal to background ratio measured over four separate data collections from different times of the day during the experiment described above. The scintillation index was calculated twice for each sample collection, first with an assumed constant background represented by the average of the pre and post background measurements, and then using the real-time out-of-band background measurement scaled by R. Characteristically, turbulence increases through the afternoon and drops dramatically during the night, this was reflected in the experimental results. Note that both the real-time and traditional methods of background subtraction yielded similar measures of the scintillation index when signal-to-background ratio (SBR) was high. As stated earlier, this was because as background contributed less to a received intensity any uncharacterized fluctuations during sample collection had less of an effect on the scintillation index. However, as the signal became weaker and closer to the background those fluctuations had a more drastic effect on the scintillation index. This showed that in times of low SBR the assumption of a constant background may have caused errors in the calculated scintillation index. Due to the large collecting optics aperture used in the experiment, averaging caused a decrease in measured scintillation. Correcting these scintillation index calculations would have further separated the real-time and traditional methods of background subtraction. In the case of little to no aperture averaging a source's intensity would be recorded at a lower SBR more frequently due to the increased number of fades, thus increasing its sensitivity to background measurement errors. Although not discussed here, the effects on the probability distribution function (PDF) of irradiance are of interest. An improved background measurement yields improved accuracy when the SBR is close to unity resulting in more accurate data points in the lower tail of the PDF.

From the above description of the an optical signal isolation apparatus 10 and the method 36 for using the an optical signal isolation apparatus 10, it is manifest that various techniques may be used for implementing the concepts of apparatus 10 and method 36 without departing from the scope of the claims. The described embodiments are to be considered in all respects as illustrative and not restrictive. The method/apparatus disclosed herein may be practiced in the absence of any element that is not specifically claimed and/or disclosed herein. It should also be understood that apparatus 10 and method 36 are not limited to the particular embodiments described herein, but are capable of many embodiments without departing from the scope of the claims.

We claim:

1. A method for isolating an optical signal comprising the following steps:
receiving the optical signal from a transmitter with a receiver after the optical signal has propagated through a turbulent medium separating the transmitter from the receiver;
splitting the received signal into first and second signals;
filtering the first signal with an in-band, optical spectral filter to create an in-band signal centered at an operating wavelength of the transmitter;
filtering the second signal with an out-of-band, optical spectral filter to create an out-of-band signal slightly out-of-band with respect to the operating wavelength of the transmitter; and
subtracting the out-of-band signal from the in-band signal with a balanced detector in order to generate an output signal, whereby the output signal is a real-time representation of the intensity of the optical signal without background intensity.

2. The method of claim 1, further comprising the step of calculating a scintillation index SI of the turbulent medium according to the following:
$$SI = \frac{〈 {I}^{2} - I 〉}{{〈 I 〉}^{2}} = \frac{〈 {I}^{2} 〉}{{〈 I 〉}^{2}} - 1$$
where I is the output signal.

3. The method of claim 1, wherein the output signal is an electrical current.

4. The method of claim 3, wherein the balanced detector comprises first and second photodiodes with equal responsivity connected in series such that electrical current induced in the first diode is subtracted from the second diode by a shunt at the connection between the first and second diodes.

5. The method of claim 4, further comprising the step of adjusting diode bias points in the first and second diodes with external feedback circuitry to compensate for differences in inherent photodiode responsivity.

6. The method of claim 1, wherein the optical signal is a laser beam.

7. The method of claim 1, wherein the optical signal is radiation from a light emitting diode.

8. The method of claim 5, further comprising the step of modulating a transmission source of the optical signal to allow auto-balancing of diodes during off portion of signal duty cycle.

9. The method of claim 1, wherein the receiver comprises two telescopes configured to be used as inputs into the balanced detector.

10. The method of claim 1, wherein the splitting step is accomplished with a beam splitter.

11. The method of claim 1, wherein the splitting step and filtering steps are accomplished with a dichroic mirror.

12. The method of claim 1, wherein the turbulent medium is the Earth's atmosphere.

13. The method of claim 1, wherein the out-of-band signal is filtered close to, but outside of, the transmitter's wavelength such that the transmitter has no effect on the out-of-band signal.

14. An optical signal isolation apparatus comprising:
a receiver configured to receive an optical signal from a transmitter after the optical signal has propagated through a turbulent medium;
an optical device optically coupled to the receiver and configured to split the optical signal into first and second signals;
an in-band, optical, spectral filter configured to filter the first signal to create an in-band signal centered at an operating wavelength of the transmitter;
an out-of-band, optical, spectral filter configured filter the second signal to create an out-of-band signal that is slightly out-of-band with respect to the operating wavelength of the transmitter; and
a balanced detector configured to subtract the out-of-band signal from the in-band signal in order to generate an output signal, whereby the output signal is a real-time representation of the intensity of the optical signal without background intensity.

15. The apparatus of claim wherein a dichroic mirror functions as the optical devices and the in-band and out-of-band spectral filters.

16. The apparatus of claim 14, wherein the output signal is an electrical current.

17. The apparatus of claim 16, wherein the balanced detector comprises first and second photodiodes with equal responsivity connected in series such that electrical current induced in the first diode is subtracted from the second diode by a shunt at the connection between the first and second diodes.

18. The apparatus of claim 17, further comprising external feedback circuitry configured to adjust diode bias points in the first and second diodes to compensate for differences in inherent photodiode responsivity.

19. The apparatus of claim 17, wherein the optical signal is a laser beam.

20. The apparatus of claim 14, wherein the wavelength of the out-of-band signal is several nanometers away from the operating wavelength of the transmitter.
